(19) United States
(12) Patent Application Publication
(10) Pub. No.: US 2005/0012417 A1
(43) Pub. Date: Jan. 20, 2005

(54) Machine especially generator

(76) Inventors: Henning Fasterding, Markgroeningen (DE); Walter Csciser, Schwieberdingen (DE); Rainer Danylak, Tamm (DE); Karl Auer, Stuttgart (DE)

Correspondence Address: Striker Striker & Stenby, 103 East Neck Road, Huntington, NY, 11743, US

(21) Appl. No.: 10/498,536

(22) PCT Filed: Jan. 27, 2003
(86) PCT No.: PCT/DE03/00213

(30) Foreign Application Priority Data
Mar. 28, 2002 (DE) 102 14 276.9

(51) Int. Cl. H02K 5/16; F16C 25/00; H02K 7/08

(52) U.S. Cl. 310/90; 384/611; 384/620

(57) ABSTRACT

The invention relates to a machine, in particular a generator, which has a bearing (19) supported on a hub (22), whereby a bearing part of the bearing (19) is loaded by a spring element (25) producing an axial force (FA). The spring element (25) is plastically deformed.

### BACKGROUND INFORMATION

The present invention relates to a generator according to the general class of the independent claim.

A generator is known from DE 19804328 A1, in the case of which the generator shaft is supported by a movable bearing in the vicinity of a housing part. A spring element inserted in the hub loads the outer ring of the movable bearing with an axial force to achieve a defined rolling movement of the rolling body in the movable bearing and thereby achieve a longer service life of the movable bearing. Due to the selected axial fixation of the spring element using a special spring disk, the movable bearing design disclosed in the publication named hereinabove results in a hub that is axially relatively large in size. In addition, the fixation of the spring elements disclosed therein allows only a limited amount of pretensioning force to be achieved. Moreover, a relatively complicated configuration of the parts is necessary to achieve an axial pretensioning force. Due to production tolerances in the assembly process, the adjustment of the axial pretensioning force is not guaranteed with sufficient accuracy, and it is an additional assembly process.

### ADVANTAGES OF THE INVENTION

The generator according to the invention having the features of the main claim has the advantage that, due to the plastically deformed spring element and the spring characteristic curve of the spring element that is therefore utilized in the plastic range, a well-defined axial force is achieved with relatively great spring travel during assembly in a relatively narrow force range.

Advantageous further developments of the generator according to the main claim are possible as a result of the measures listed in the subclaims. If the spring element has a spring constant c between 18 and 70 N/mm in the plastic range, a sufficiently accurate axial force is attained by the spring element across the compression travel of the spring element given standard tolerances for the generator components.

A particularly favorable compact design of the spring element results when the plastic range begins after an elastic compression travel between 3 and 3.5 mm. If the plastic range begins below 1.5 mm, the tolerances to be selected for the pretensioned components must be so low that fabrication is too expensive. If a greater elastic compression travel is selected, an undesired axial extension of the hub is attained. To prevent the pretension and/or axial force on the bearing from becoming too great when the plastic range of the spring element is fully utilized, it should be possible to adjust a change in axial force ΔFA of 100 N across a plastic compression travel between 1.5 and 3.5 mm. In favorable cases, axial force FA is between 350 N and 650 N. If the axial force is lower, the service life of the movable bearing is greatly limited, since the rolling movements of the rolling bodies are not ideal. If the axial force is greater than 650 N, the service life of the bearing is reduced due to the increased pressing of rolling bodies between the bearing rings.

The spring element is centered by the hub. This provides an advantage, namely that the spring element does not bear against the bore of the hub, which would result in a loss of axial force, which could reduce the axial force on the movable bearing.

According to a further embodiment, it is provided that the spring element has a carrier region from which at least one spring arm extends. The carrier region has the task of acting as a centering element and therefore offers a good hold for the at least one spring arm. A particularly space-saving design results due to the fact that the at least one spring arm extends in the peripheral direction.

To achieve a favorable material utilization with the spring element, it is provided that cross sections of the spring element loaded with the axial force are exposed to essentially identical mechanical loads.

### DRAWING

FIG. 1 shows a machine with a cross-sectional view through the movable bearing.

FIG. 2 shows a spacial view of the spring element.

FIG. 3 shows a top view of the spring element.

FIG. 4 shows a force-travel diagram for the course of axial force across the compression travel of the spring element.

### DESCRIPTION

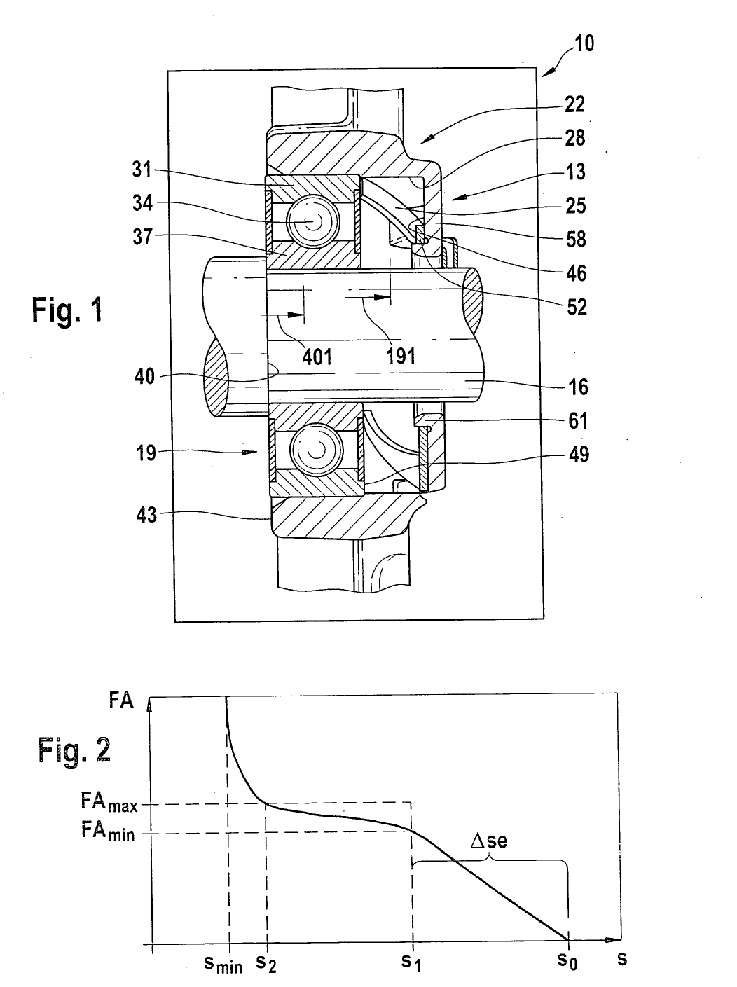

In FIG. 1, a machine 10 and, here in particular, one of its bearing arrangements 13, is depicted in a sectional view. The parts of bearing arrangement 13 are a shaft 16, a bearing 19, a hub 22, and a spring element 25. Hub 22 is part of a bearing plate and accommodates bearing 19, designed as rolling bearing, with its outer ring 31 in its cylindrical bore 28. Bearing 19 carries shaft 16 using rolling bodies 34 and an inner ring 37. In this example, machine 10 is designed as a generator, whereby shaft 16 is usually composed of steel, and hub 22, which is configured integral with the bearing plate, is composed of an aluminum alloy.

For the fabrication of machine 10, different linear tolerances—axial linear tolerances, in this case—apply for the individual components of machine 10 to be manufactured. When individual parts that are manufactured individually are combined, extreme combinations result. With machines 10 configured as generators, an attempt is usually made to compensate for the different tolerances in a bearing arrangement 13 facing away from the machine drive. Due to the different linear tolerances, the axial position of a shaft shoulder 40 can be different than that of an end surface 43 of hub 22, for example. An extreme position is depicted in FIG. 1. Another extreme position 401 is also sketched, in which shaft shoulder 40 is shifted further to the right due to production tolerances. The position of bearing 19 on shaft shoulder 40 also shifts, so that a side of bearing 19—shown on the right in the illustration—moves to position 191.

If, given a variability in tolerance position of this nature, machine 10 is no longer driven by a belt, as is standard, but rather via gears internal to an internal combustion engine, for example, a bearing force acting in the radial direction is lacking in the bearing arrangement 13, which would otherwise result in a defined rolling of rolling body 34 in bearing 19.

In installation and drive cases of this nature, a spring element 25 is provided inside bearing arrangement 13 that, due to its axially-acting force, causes outer ring 31 to shift in the direction toward shaft shoulder 40, thereby bringing about a radial force on rolling body 34. If this radial force reaches a certain minimum amount, a defined rolling of rolling body 34 is induced, and the service life of bearing 19 can therefore be extended. Spring element 25 must produce an axial force FA on bearing 19 within the extreme positions that occur, the axial force being located within a certain range. With the variant of a bearing arrangement 13 depicted in FIG. 1, spring element 25 loads bearing part outer ring 31 with axial force FA. With variabilities that are this great, to ensure that the axial force acting on the bearing part is neither to small nor too great, it is provided that the spring element is plastically deformed while it exerts axial force on the bearing part in the installed state. FIG. 2 shows a power-force diagram of the spring element. Travel s is shown on the x-axis and axial force FA is shown on the y-axis. Starting at the beginning, variable s0 represents the axial length of spring element 25 in the unloaded state. If spring element 25 is now compressed axially, the axial extension of spring element 25 is reduced. After the elastic compression travel Δse has been completed, the spring element has axial extension s1. After this value, i.e., if spring element 25 is compressed even further, the deformation of spring element 25 is plastic. When axial expansion s1 of spring element 25 is reached, the minimally required axial force FAₘᵢₙ is simultaneously reached. The force-travel curve is now clearly flatter than the force-travel curve in the elastic range of spring element s25. With regard for bearing arrangement 13, variable s1 means that s1 is the maximum permissible axial extension of spring element 25 in bearing arrangement 13. s1 therefore corresponds to the maximum installation length between an end face 46 in hub 22 and a right end face 49 of bearing 19. Axial extension s2 is permissible as the minimal distance between end faces 46 and 49, refer also to FIG. 2. The definition of s2 is that, given this axial extension of spring element 25, a maximum permissible axial force FA is barely not exceeded.

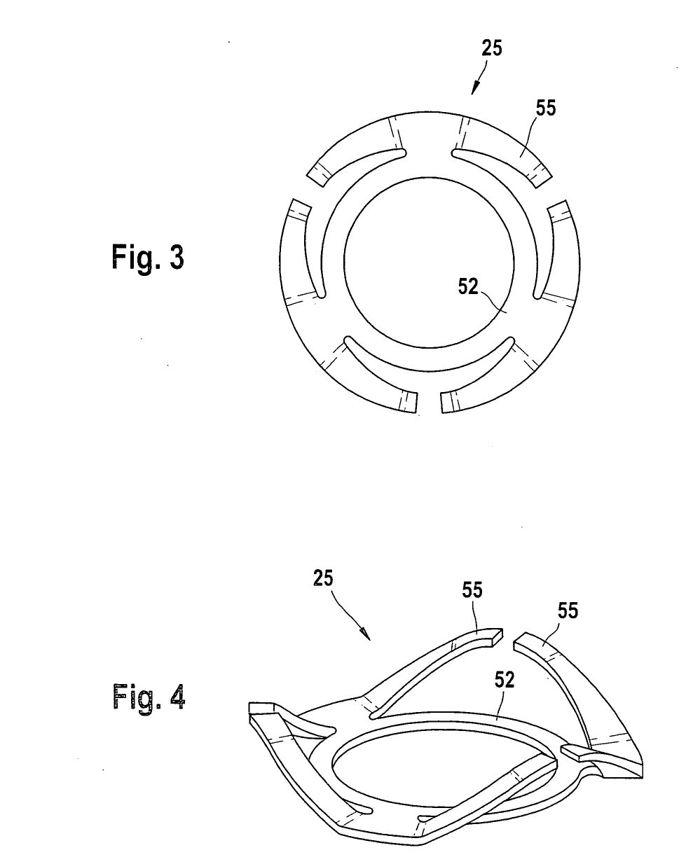

The structural design of spring element 25 is explained in greater detail with reference to FIGS. 3 and 4. In the top view of spring element 25, a carrier region 52 that is preferably configured annular in shape is clearly shown. A plurality of spring arms 55 extend away from this carrier region 52 on its radial outer side. As a minimal requirement with regard for spring element 25, it is provided that at least one spring arm 55 extends away from carrier region 52. This at least one spring arm 55 extends in the peripheral direction in relation to the axis of shaft 16 of machine 10. To achieve the most favorable utilization of installation space possible for spring element 25, two spring arms 55 each extend from the periphery of carrier region 52, starting at a point on the circumference, the spring arms pointing away from each other. Spring arms 55 have cross sections configured such that the axial force load causes essentially identical mechanical loads in spring arms 55.

Carrier region 52 enables spring element 25 to be centered by hub 22, refer also to FIG. 1. For this purpose, it is provided that hub 22 has a radially inwardly directed projection 58 that ends in an axially oriented projection 61 shortly before it reaches shaft 16. This shaft 61 has a radially outwardly machined surface, and via this, centers carrier region 52—and, therefore, spring element 25—on its inwardly oriented contour.

Various physical properties for spring element 25 have proven particularly favorable. To ensure that only permissible axial force increases occur across the plastic compression travel between s1 and s2, it is provided that the spring constant is between 18 and 70 N/mm, in accordance with the standard definition. Moreover, it has been shown that the plastic range of deformation of spring element 25 favorably begins after an elastic compression travel between 2 and 3.5 mm. It has also been shown that the change in axial force ΔFA in a plastic compression travel between 1.5 and 3.5 mm is favorably located in a range of 100 N. For a favorable service life forecast of bearing 19, it is necessary that spring element 25 produce an axial force FA of 350 to 650 N.

1. A machine, in particular a generator, is disclosed, with a bearing (19) supported in a hub (22), whereby a bearing part of the bearing (19) is loaded by a spring element (25) producing an axial force (FA),
whereby the spring element (25) is plastically deformed.

2. The machine as recited in claim 1,
wherein the spring element (25) has a spring constant between 18 and 70 N/m in the plastic range.

3. The machine as recited in claim 1, wherein the plastic range begins after an elastic compression travel Δse between 2 and 3.5 mm.

4. The machine as recited in claim 2,
wherein a change in axial force ΔFA of 100 N is capable of being adjusted in a plastic compression travel between 1.5 mm and 3.5 mm.

5. The machine as recited in claim 1, wherein the spring element (25) acts with an axial force FA between 350 N and 650 N.

6. The machine as recited in claim 1, wherein the spring element (25) is centered by the hub (22).

7. The machine as recited in claim 1, wherein the spring element (25) has a carrier region (52), from which at least one spring arm (55) extends.

8. The machine as recited in claim 7,
wherein the at least one spring arm (55) extends in the peripheral direction.

9. The machine as recited in claim 1, wherein cross sections of the spring element (25) loaded with the axial force are exposed to essentially identical mechanical loads.

10. The machine as recited in claim 1, wherein the bearing (19) is a movable bearing.
